(19) United States
(12) Patent Application Publication
(10) Pub. No.: US 2002/0016726 A1
(43) Pub. Date: Feb. 7, 2002

(54) Package delivery systems and methods

(76) Inventor: Kenneth J. Ross, Fairfield, IA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/855,568

(22) Filed: May 14, 2001

Related U.S. Application Data
(60) Provisional application No. 60/204,224, filed on May 15, 2000.

(51) Int. Cl. G06F 17/60

(52) U.S. Cl. 705/7

(57) ABSTRACT

The present invention provides a method and system for delivering packages to a depot delivery destination selected by a customer for package pickup. Participating home shopping merchants allow customers to purchase goods at home and to ship their purchases to a nearby depot delivery destination to be picked up when convenient. The packages from the home-shopping merchants are stored in a secure unit at the depot's customer service center until customer pickup. The delivery system of the present invention is designed to provide consumers with package security from order to final delivery. The delivery system present invention may also provide the customers with the ability to track their orders at any time without the intervention of merchant customer service personnel.

### CROSS-REFERENCES TO RELATED APPLICATIONS

The present application claims priority to U.S. Provisional Patent Application Serial No. 60/204,224, filed May 15, 2000, which is incorporated herein by reference in its entirety.

### BACKGROUND OF THE INVENTION

The present invention relates to package delivery systems and methods. More specifically, the present invention relates to systems and methods for delivering packages to a depot delivery destination for pick up at a customer's convenience.

As work and personal demands increase, consumers are experiencing a rapid decrease in time available for activities such as retail shopping. In response, mail order, online electronic shopping and other home shopping services have grown rapidly as consumers demand more convenience, selection, delivery options and security. With 70% of today's households having all the adults working, there is often no one home to receive merchandise nor is there time during working hours to visit a carrier's (e.g., United Postal Service, Federal Express, Airborne, etc.) distribution center to pick up a package ordered from such home shopping merchants. It is often inconvenient for customers to pick up packages at the carrier's locations, because of their inconvenient locations, very limited hours, and poor service even when the carrier does not add on a pickup charge. Some carriers provide Saturday delivery. However, Saturday delivery can be undesirably expensive for customers (e.g., $10).

Increasingly, customers do not want to have their packages left on their doorstep exposed to theft or weather damage while they are out. With the rapid growth of home shopping, the potential for theft or loss could grow substantially, severely restricting merchant package delivery options. For mail order and electronic commerce to continue its growth, customers must be assured of the security of both their payment information and the delivery of their order.

Many customers chose to pick up their packages at a local U.S. post office. However, long lines, limited hours, poor service and unreliable delivery by the post office make this a poor option for consumers and merchants alike. The vast majority of home shopping packages are shipped via United Postal Service (UPS) because of that carrier's greater reliability and trackability of shipments, depending on the shipping options. Because the U.S. Postal Service (USPS) is not integrated with merchants, each merchant must call customers to find out if they received their orders or must wait for a customer complaint.

Some consumers may be able to have their package delivered to their place of work. However, because of cost and liability concerns, most employers discourage this. With home shopping growth rapidly, it can be expected over the next few years that more and more employers will restrict such personal deliveries to the workplace as the real costs of providing this service to employees materializes.

Packages can also be delivered to the closest Mail Boxes, Etc. store. While Mail Boxes, Etc. (MBE) stores can be secure places for customers to receive packages, consumers often find number and locations of MBE locations limited and inconvenient. Also, it is difficult to track a lost package with MBE, because merchants have no way of knowing if the customer received their order short of calling the customer for each delivery.

In another previously known system originally deployed by PackageNet and now deployed by Neopost Online, Inc. under the mark SimplyPackages^{SM}, consumers wishing to ship outbound packages via UPS can drop them off at their favorite participating SimplyPackages location (e.g., a local supermarket). Through toll-free number locator system, Neopost Online's Returns Made Easy^{SM} system directs customers of major catalogs to nearby participating SimplyPackages supermarkets where they can ship merchandise returns while they shop for groceries.

### BRIEF SUMMARY OF THE INVENTION

The present invention provides a package delivery system that delivers merchandise purchased through home shopping merchants to a depot delivery destination conveniently located near the customer. Embodiments of the present invention also provide additional functionality such as tracking shipments of packages, linking shipments of packages with a purchased item, and providing customers with easy access to package shipping and tracking information.

The present invention provides methods and systems for delivering packages to any participating depot for package pickup. The participating depots ideally include numerous locations that are convenient to millions of customers. Participating home shopping merchants allow customers to purchase goods at home and to ship their purchases to a nearby depot to be picked up when convenient. The packages from the home-shopping merchants are stored in a secure unit at the depot's customer service center until customer pickup. The depots (such as supermarkets) typically have more convenient hours (e.g., evenings and weekends) than the U.S. Postal Service or UPS distribution centers.

The delivery system of the present invention is designed to provide consumers with package security from order to final delivery, and the ability to track orders at their convenience, at any time without the intervention of merchant customer service personnel. Tracking information provided to the customer may include an indication of whether the package has been shipped, is in transit, or has been delivered. In another embodiment of the present invention, carriers may deliver “bounce back” packages to a depot near the customer when the customer is not home to pick up a package, thereby making pick up far more convenient for the customer.

The present invention includes methods for servicing a request for delivery of a item ordered by a customer from a merchant. A server receives delivery location information from a customer such as zip code or phone number. The server uses the delivery address information to provide a set of delivery destinations (e.g., depot addresses) to the customer that may be near the customer. The delivery destinations do not include the customer's home address. The customer then selects a delivery destination and transmits it to the server. The server receives the selected delivery destination from the customer. A shipment transaction is then initiated with a carrier to deliver the item to the customer. The selected delivery destination is provided to the carrier for delivery. The server may receive package status information relating to the delivery of the item from the carrier chosen to deliver the item to the customer. The server may also receive package arrival information from the selected delivery destination indicating when the item arrives at the selected delivery destination.

In accordance with the principles of the present invention, participating home shopping merchants provide their customers with the opportunity to have purchased merchandise delivered to a conveniently located participating depot location rather than having the package delivered directly to the customer's home or work address. The customer may select the depot delivery destination for the merchandise among a list of nearby participating depots. A small fee may be added to the customer's bill as compensation for the depot delivery service. The package is delivered by a carrier service to the depot. When the package arrives at the depot, it is stored in a secure location such as a locked cabinet.

A depot system operator operates a server (referred to as the depot server) that keeps track of the packages and coordinates delivery tracking information between the merchant, the carrier, and the depot. The depot server stores lists of merchants, carriers, and depots that are participants in the delivery system of the present invention. The depot server allows customers to access package tracking information and lists of participating merchants and depots through, e.g., an interactive voice response system or through a web site.

The package delivery system of the present invention provides a safe and secure alternative to home delivery. Customers no longer have to wait at home for a package delivery or risk theft by having a package left at their front door by a carrier. The present invention also eliminates the need for carriers to make repeated attempts to deliver a package to a customer that is not home for a delivery. A carrier can send a package to a participating depot for customer pickup after a failed delivery attempt (i.e., a bounce back delivery). Depots typically have convenient locations and hours (e.g., weekends and evenings).

A further understanding of the nature and advantages of the present invention may be realized by reference to the remaining portions of the specification and the drawings.

### BRIEF DESCRIPTION OF THE DRAWINGS

FIG. 1 is a diagram illustrating an overview of the package delivery system of the present invention;

FIG. 2 is a diagram illustrating an example of a computer system network for handling the delivery and tracking of packages shipped in accordance with the principles of the present invention;

FIG. 3 is a flow chart illustrating example steps that may be followed in accordance with the package delivery system of the present invention;

FIG. 4 is a flow chart illustrating example steps that may be followed for delivering bounce back packages in accordance with the principles of the present invention;

FIG. 5 is a flow chart illustrating example steps that may be followed in handling a damaged packaged delivered in accordance with the principles of the present invention;

FIGS. 6A-6B are flow charts illustrating example steps that may be followed in handling a lost packaged delivered in accordance with the principles of the present invention;

FIGS. 7A-7B are flow charts illustrating examples steps that may be followed in Internet and phone tracking systems in accordance with the principles of the present invention;

FIGS. 8A-8B are illustrations of example web pages that may be provided to a customer while selecting a package delivery system in accordance with the principles of the present invention;

FIG. 9 is an illustration of an example web page that may used to provide a customer with package tracking information in accordance with the principles of the present invention; and

FIG. 10 is an illustration of an example screen that may be used to provide package tracking information to a depot delivery destination in accordance with the principles of the present invention.

### DETAILED DESCRIPTION OF THE INVENTION

Overview of the Package Delivery System

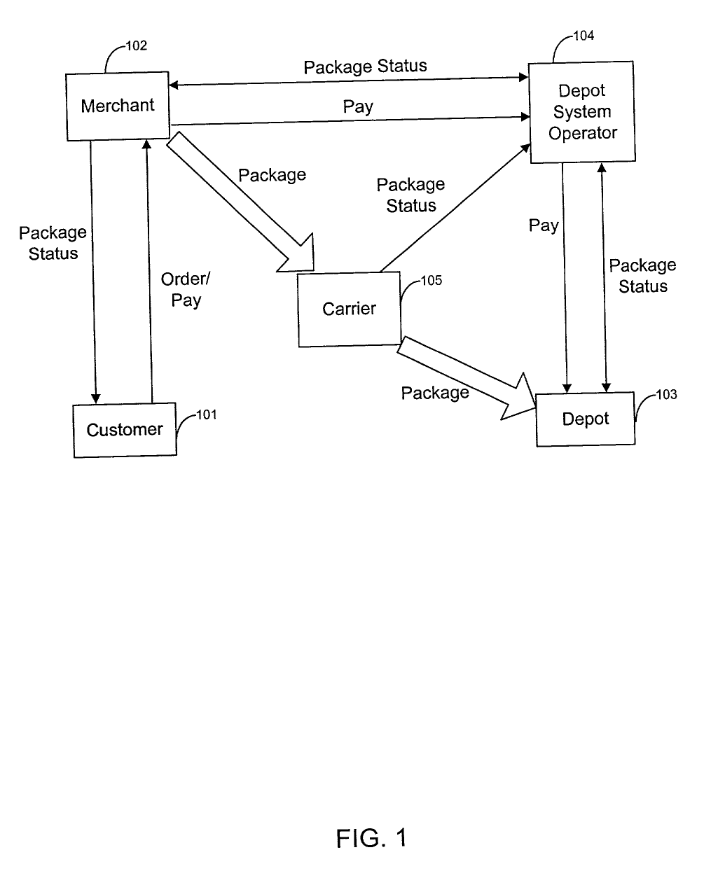

FIG. 1 is a diagram illustrating an overview of the package delivery system of the present invention. Referring to FIG. 1, a customer 101 may order a item of merchandise from a merchant 102 through an Internet web site or over the phone (e.g., from a mail order catalog merchant or a television channel home shopping network). Customer 101 pays merchant 102 for the merchandise (e.g., credit card transaction). Merchant 102 may provide the customer with an order number for the merchandise. Merchant 102 can provide the customer with an option to have the package delivered to a depot 103 destination selected by customer 101 instead of home delivery. Depot 103 may be, for example, a retailer such as a grocery store, a department store, a drug store, a home furnishings store. etc.

If customer 101 selects the depot delivery option, merchant 102 then pays a depot system operator 104 for its package tracking, data storage, and accounting services, which are discussed in further detail below. A carrier 105 (e.g., UPS, Airborne, FedEx, USPS, etc.) picks up a package containing the purchased merchandise and delivers it to depot 103. Depot 103 holds the package in a secure location until customer 101 picks it up from depot 103 at his or her convenience. Merchant 102, carrier 105 , and depot 103 may each transmit information electronically to depot system operator 104 indicating the current delivery and shipment status of the package as shown in FIG. 1. For example, carrier 105 may send a message to depot system operator 104 indicating when it dropped off the package at depot 103. Depot system operator 104 may also transmit package status information back to merchant 102 and depot 103.

The depot system operator 104 may maintain all of the package delivery status information in its databases regulated by a depot server, or it may access certain delivery status information in real time through a network connection. The depot server may make the package status information available to merchant 102, carrier 105, depot 103, and customer 101. For example, the depot server can inform depot 103 that a package is in transit and that it is expected to arrive on a certain date.

Customer 101 may, for example, call a voice response unit maintained by depot system operator 104 to access the package status information stored in the depot server. If desired, depot system operator 104 may maintain an Internet web site that interfaces with the depot server database. Customer 101 may log onto the depot system web site to obtain package status information at the customer's convenience. Alternatively, merchant 102 may maintain a web site which interfaces with the depot server database to provide package status information directly to customer 101.

Package Delivery System Architecture

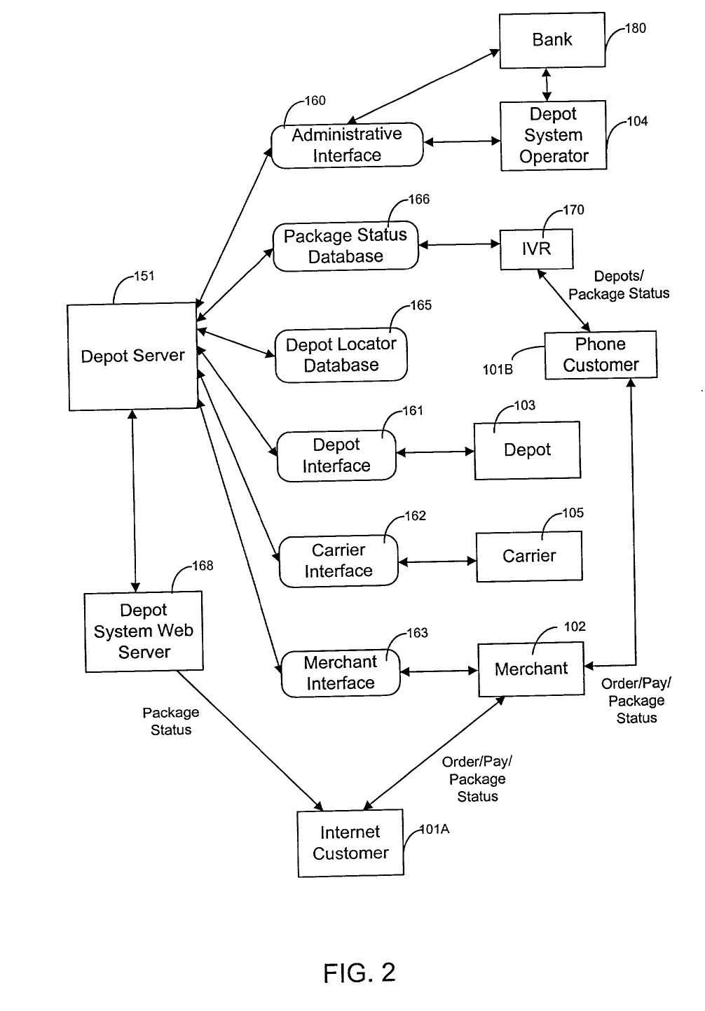

FIG. 2 is a diagram illustrating a more detailed example of the delivery system architecture of the present invention. The architecture in FIG. 2 provides one illustrative example of the hardware system of the present invention. Other hardware configurations may also be used to provide the features of the delivery system of the present invention discussed below. FIGS. 1 and 2 illustrate one customer, one merchant, one carrier, and one depot to avoid overcomplicating the drawings. In general, a network of numerous customers, merchants, carriers, and depots are typically involved in the delivery of packages in accordance with the present invention.

The package delivery system of FIG. 2 is coordinated by a depot server 151, which may, for example, be a dedicated computer that is located at an Internet Service Provider's site. Depot server 151 coordinates access to information through a set of interfaces, each of which provides distinct services to the participants in the delivery system. The set of interfaces include a administrative interface 160, a depot interface 161, a carrier interface 162, and a merchant interface 163. Interfaces 160-163 comprise software programs which may or may not reside on their own dedicated computer hardware such as a server. Interfaces 160-163 provide a defined interface and secure access for participants to modify and/or query data maintained by depot server 151.

Only depot system operator 104 may directly access data on depot server 151 through administrative interface 160. Depot system operator 104 has full access to all the data in databases maintained by depot server 151. Administrative server 160 provides an interface for depot system operator 104 to update, monitor and extend the capabilities of the package delivery system. Depot system operator 104 may include a server and clients (or other computer system) that are used to access and manage depot server 151 databases, executable code, certain levels of passwords, etc.

Administrative interface 160 may comprise a simple, secure web browser interface from which depot system operator 104 personnel may browse depot server 151 databases from their computers to determine if packages have been shipped from merchants, have arrived at depots, or have been picked up by customers. Administrative interface 160 may allow depot system operator 104 personnel to search packages in depot server 151 databases by date range, customer, depot, order number, tracking number, merchant or carrer.

Depot server 151 may have the capability to indicate via e-mail to merchant 102, carrier 105, and depot 103 that it is down and not to send transactions until it receives a “Depot Server Ready” message. Similarly, the merchant's system administrator may send a message indicating its system is down or up. The sending of such an e-mail may require a special password included in the subject of the message.

Depot server 151 may, for example, maintain data in two databases, a depot locator database 165 and a package status database 166. Depot locator database 165 and package status database 166 may be stored on depot server 151 or on their own dedicated server or servers. Depot locator database 165 maintains a current list of all participating depots that are currently accepting package deliveries, including addresses and maps of the depots. Depot locator database 165 provides this data for an Internet customer 101A, a phone customer 101B, merchant 102, and carrier 105. Thus, merchant 102 may maintain a web server that can access depot locator database 165 through depot server 151 and provide Internet customer 101A with a list of nearby participating depot locations.

Internet customer 101A may also determine participating depot locations that accept package deliveries and obtain package delivery status information directly from a web page maintained by the merchant or depot or web site maintained on a depot system web server 168 (e.g., http://www.simplypackages.com/packagenet.asp). Web server 168 has access to location and package status databases 165-166 by connecting to depot server 151. If desired, the depot system web server 168 may reside at the same ISP as depot server 151.

Package status database 166 receives, integrates, and stores package status information from merchant 102, carrier 105, and depot 103, and distributes the information to these participants on-demand through corresponding software interfaces 161-163. Package status information stored on database 166 may include, for example, an estimated arrival date of the package at the depot delivery destination, an actual arrival date at the depot, a package tracking number, a customer order number, a method of transportation of the package, size and weight of the package, and whether the package has been lost or damaged.

Package status database 166 provides package status information on-demand to customer 101B through an interactive voice response system (WR) 170 or to customer 101A through the Internet (e.g., through a merchant 102 web site). Customer 101A can interface through the merchant 102 web page to select a depot delivery destination and to get package status information, because data is provided to the merchant 102 web server from depot locator database 165 and package status database 166. If desired, carrier 105 may also maintain a web server that provides package status information from database 166 to customer 101A.

Merchant interface 163 allows merchant 102 to update depot server 151 with new depot delivery accounts, new package shipments, and package shipment status updates. Merchant 102 communicates with depot server 151 to open new depot delivery accounts and to indicate when a package has been shipped to a carrier. Merchant 102 may also transmit a customer order number to depot server 151. Merchant 102 may communicate with depot server 151 using a merchant web server or other computing system.

Merchant interface 163 also allows depot server 151 to provide data to merchant 102 in a convenient manner. Depot server 151 can provide package status information, administrative services, and accounting services specific to merchant 102 to its web server (or other computer).

Merchant 102 may regulate a merchant web page through which customer 101A purchases merchandise. Depot server 151 can transmit package tracking information received from the carrier and the depot to merchant 102 so that customer 101A/101B may access this information from the merchant web page or by calling a phone number. Depot server 151 corresponds customer order numbers with carrier tracking numbers so that customers and merchant customer service personnel can get information indicating the delivery status of the package from depot server 151 by using the order number. Package delivery status information and carrier tracking numbers are received from carrier 105.

Merchant 102 can receive its past transactions, payments, and information relating to delivery of its packages from depot server 151. Merchant 102 can download all this information onto their own servers and databases. Merchant security may be provided through a merchant specific user ID and password which is required to access proprietary merchant information on depot server 151.

Depot delivery destination information (e.g., addresses and maps of the depots) and other non-merchant specific information stored in depot locator server 165 is available to merchant 102. Merchant 102 can also access depot system web server 168 to obtain the identity and location of the depots. Merchants can also get a regular update of depot delivery destination information that can be added to the merchant's database through other communications means such as e-mails from depot server 151. Customer 101B may determine the nearest participating depot delivery location prior to ordering from merchant 102 by calling interactive voice response system 170.

Carrier interface 162 provides a software interface that allows carrier 105 to update package status database 166 (through depot server 151) with new deliveries and delivery status updates (e.g., lost/damaged packages). Depot server 151 can provide package status information (from merchant 102, depot 103, or previously provided by carrier 105), administrative services, and accounting services to carrier 105 through interface 162. If depot server 151 coordinates payments to or from carrier 105, carrier 105 can log on to depot server 151 through interface 162 to view its transactions and payments. For example, depot system operator 104 may charge carrier 105 a fee for the privilege of delivering a bounce back package to a depot delivery destination. Carriers may have password protected access to their data.

Clerks at carrier 105 enter package status information such as tracking number and package size/weight into a server or other computer system maintained by carrier 105. Depot server 151 polls this computer at carrier 105 to update package status database 166 with the package status information stored on the carrier's computer. Depot server 151 may check the carrier's computer for any packages that have arrived at depot 103. The delivery system of the present invention may use a direct dial up connection using HTTP, SMTP, and POP3 protocols to depot server 151 to bypass the Internet.

Depot 103 has a server or other computer system that receives information indicating incoming packages from depot server 151 through interface 161. Depot server 151 may provide package pending and status information as well as administrative and accounting services to depot 103. Depot 103 communicates electronically with depot server 151 through depot interface 161 to indicate when particular packages have been dropped off by carrier 105 and when customers have picked up particular packages.

Depot 103 can access package status database 166 through depot server 151 to obtain package status information including an estimated time of arrival for packages being delivered to depot 103. Depot 103 administrative and accounting information is only available to depot 103 and depot system operator 104 for security reasons. Depots may have password protected access to their data.

Depot 103 can communicate with depot server 151 to indicate when its secure storage cabinets are full such that it cannot accept any more new deliveries of packages. Depot 103 can send a message to depot server 151 when its cabinets have available space again. Depot server 151 can thereby maintain an up-to-date database, indicating which participating depots are currently accepting deliveries.

Because of the value of depot space, it may not be possible to hold packages indefinitely at the depot. Holding charges may be applied to packages that remain at the depot after a certain number of days. The delivery system software at depot server 151 may automatically monitor when the holding period has expired (e.g., a period of time after the package is first received and logged in at a depot 103 computer). Depot server 151 may automatically bill merchant 102 (or the customer) for holding charges. Depot server 151 may remit a portion of the holding charges received from merchant 102 to depot 103.

Packages may be returned to merchant 102 or picked up by carrier 105 after an expiration period. A depot clerk re-labels the package and ships it back to merchant 102. A computer at depot 103 may have software which prints out a label with the merchant's address that can be affixed to the package and logs the package on depot server 151 as returned. Depot server 151 may automatically send an e-mail message the customer indicating that the holding or expiration period has expired or will expire soon and that further charges may be applied.

If desired, depot server 151 may provide customers with the opportunity to extend the expiration period for an additional fee. Customer 101A may log on to the depot system web site at server 168 or the merchant web site to connect to depot server 151. Customer 101A may then indicate to depot server 151 that he wishes to extend the expiration period for an additional fee charged to the customer's account or credit card. Depot server 151 can send an electronic message to depot 103 to extend the expiration time period by the appropriate number of days.

Merchant 103 may have a telephone system that can take a customer order number input from phone customer 101B and announce package status data obtained from database 166 back to customer 101B. The merchant 103 telephone system can also provide depot identity and location information. Interactive voice response system 170 also interfaces with package status database 166 to provide up-to-date package status information (e.g., expected date of arrival, tracking number, etc.) to phone customers 101B. Interactive voice response system 170 may use a prerecorded voice with a minimum of text-to-speech conversion.

Direct access to depot server 151 may be restricted to depots, merchants and carriers, which each have their own passwords for access to data regarding their specific packages and transactions. Participants may be given the ability to do ad hoc queries in databases 165 and 166 for reporting purposes. However, each participant's access may be limited to tables which contain only their transactions. The depot, merchant and carrier interfaces 161-163 act to limit and filter access by the participants to depot server 151 databases 165 and 166. Depot server 151 may also maintain databases (not shown) that include participant payment information such as invoice numbers, charges, payments and credits, and other accounting information. Merchants, depots, and carriers may use a firewalls and proxy servers to connect to depot server 151 to prevent hacking of their systems.

A bank 180 may also have access to depot server 151 through administrative interface 160. Bank 180 maintains financial accounts relating to the package delivery system of the present invention for merchant 102, carrier 105, depot 103, and customer 101. Administrative server 160 may transfer finds to and from bank 180 in response to delivery transactions logged by depot server 151. Depot system operator 104 may have direct access to the financial accounts maintained by a server (or other computer system) at bank 180.

Depot server 151 can generate invoices, credits and accounting statements and send them to the relevant participants, depot 103, customer 101, carrier 105, or merchant 102. The financial data at bank 180 can be sent to depot server 151 for electronic transmission to the relevant participant. Depot server 151 can handle accounts receivable and accounts payable to each of the participants in the delivery system. Depot server 151 can keep track of disputed accounts, late payments, payments due, and other accounting information in its databases.

Package Delivery Methods

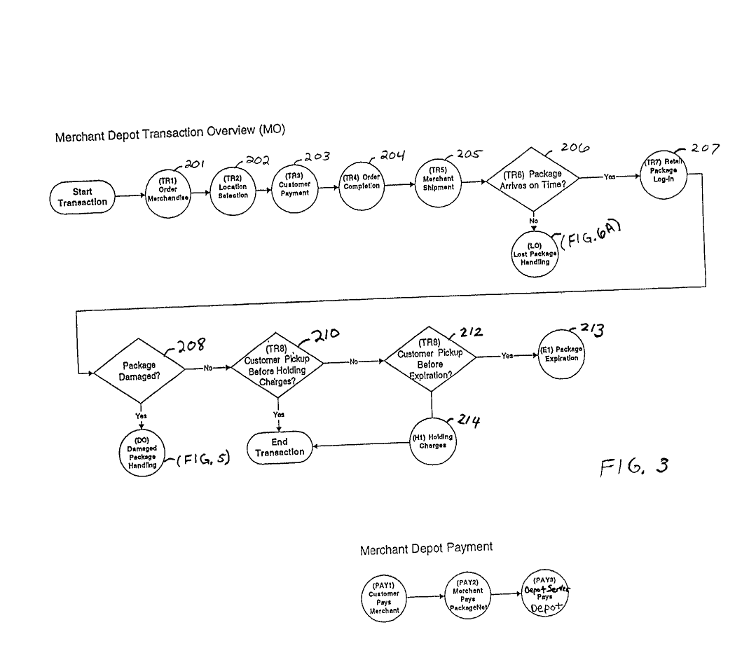

FIG. 3 shows a flow chart illustrating example steps that may be followed to implement the package delivery systems and methods of the present invention. At step 201, customer 101 contacts merchant 102 over the phone or electronically through the Internet, or through an online service provider such as AOL or Compuserve. Merchant 102 provides customer 101 with an opportunity to purchase merchandise, and the customer places an order. (For simplicity, all customers making an order electronically shall generically be referred to as “Internet customers”). Merchant 102 provides customer 101 with an opportunity to enter his home address, billing address, phone number, and/or e-mail address to merchant 102. Merchant 102 then provides customer 101 with an opportunity to select a carrier service from a predetermined list of carriers approved by the merchant (e.g., UPS, FedEx, USPS, Airborne, etc.) and a type of delivery (e.g., next day air, ground delivery, etc.).

At step 202, merchant 102 provides customer 101 with an opportunity to chose to have the purchased merchandise delivered to a depot delivery destination in accordance with the present invention. The merchant's web site may provide Internet customer 101A with an opportunity to enter their zip code, address, or phone number to see a list of depot delivery destinations in his area where he can have the merchandise delivered. Merchant 102 accesses a list of depot delivery destinations from depot locator database 165. Customer 101 then clicks on one of the listed depot locations to select it as the destination of the package.

Merchant 102 may provide an Internet customer with an option to view a map indicating the location of a selected depot. Phone customers are told the names of depot delivery destinations, e.g. “any Kroger store in your area.” Phone customers may select an individual store. All location information (e.g., the maps) is stored in depot locator database 165 and is fully accessible by merchant 102. Merchant 102 then confirms the selection. Merchant 102 may also provide customer 101 with an opportunity to view depot delivery destinations in another geographic area by, e.g., entering another zip code.

At step 203, merchant 102 presents the total charges for the transaction and delivery to the customer. Merchant 102 may charge customer 101 a fee to cover overhead associated with the delivery and tracking system of the present invention in addition to the merchandise cost, shipping, handling and tax, if any. Customer 101 then pays merchant 102, for example, by credit card or other electronic payment means. The additional fee charged to customers is determined by each merchant. Merchant 102 may be charged a per package fee by depot system operator 104.

At step 204, merchant 102 confirms the customer's order and provides customer 101 with an order number, either electronically or over the phone. Merchant 102 then indicates to customer 101 an estimated time of arrival for the package and indicates when customer 101 can begin tracking the package, e.g., through a web page screen, phone message, or subsequent e-mail. Merchant 102 may disclose a toll free phone number that dials interactive voice response system 170, which customer 101 may call to track the package. This phone number may be provided to phone and Internet customers. Merchant 102 contacts the carrier service 105 to deliver a package containing the purchased merchandise to depot 103 selected by the customer.

At step 205, merchant 102 ships the package containing the purchased merchandise to selected carrier 105. Carrier 105 may place a bar code on the package to identify it. Computers maintained by merchant 102 and carrier 105 may send package status information electronically to depot server 151. Depot server 151 stores this package status information in package status database 166. The package status information may include customer name and address, order number, carrier name, carrier tracking number for the package, type of carrier service (e.g., next day delivery), depot delivery destination name and address, method of transportation, current location of the package, expected arrival date of the package at the depot, fees paid to the carrier, package size and weight, etc. Depot server 151 may correspond the merchant's order number with the carrier's tracking number for the package to facilitate the depot server's ability to link package status and tracking information.

Depot server 151 makes the package status information from carrier 105 and merchant 102 accessible to depot 103. The package status information provided to depot delivery destination 103 may include the expected arrival date, order number, carrier name, and the weight and size of the package. Depot server 151 may continuously correspond with carrier 105 to get periodically updated information indicating the status of the delivery. This package status information may be sent to customer 101, merchant 102, or depot 103.

At branch 206, an action is taken depending upon whether the package arrives on time. If carrier 105 delivers the package to depot 103 selected by the customer on time, carrier 105 records that the package has been delivered and sends updated package delivery status information electronically to depot server 151, which updates package status database 166. If the package does not arrive at depot 103 one time, lost package handling procedures are implemented as discussed further below in connection with FIG. 6A.

At step 207, a clerk at depot 103 may scan in the bar code on the package, or manually enter the tracking number indicating to the depot's computer system that the package has arrived. The depot 103 computer may update depot server 151 to indicate that the package has arrived at depot delivery destination 103 and has been logged in. If desired, depot server may poll the depot 103 computer system to access package arrival information. Electronic messages may be sent between depot 103 and depot server 151 through e-mail, the Internet, or other electronic communication means.

Once the depot server 151 database indicates that the package has arrived at depot delivery destination 103, depot server 151 can notify customer 101 (e.g., through an e-mail message or phone call) that the package has arrived. A clerk at depot 103 places the package in a secure storage facility until the customer arrives to claim it. If it is determined at branch 208 that the package that arrived at depot 103 is damaged, damaged package procedures are implemented as discussed further below in connection with FIG. 5.

At branch 210, a determination is made as to whether customer 101 picks up the package before holding charges apply. If customer 101 picks up the package before holding charges apply, the transaction is complete. Depot 103 may require that the customer provide the package order number and/or photo identification to retrieve the package. A depot clerk looks up the order number in the depot's computer system, which may access depot server 151 through interface 161 to determine if the package has arrived and is stored in the depot's cabinet. If the package has arrived, the depot clerk retrieves the package for the customer. The clerk scans the bar code on the package or enters its order number or tracking number into the depot's computer system, which then connects to depot server 151 to update package status database 166 to reflect that the customer has picked up the package. The customer may be required to sign a form indicating the package has been received.

If customer 101 does not pick up the package before holding charges apply, a determination is made as to whether customer picks up the package before the end of the expiration period at branch 212. Holding charges are applied to the customer's account at step 214 if customer 101 picks up the package after holding charges apply, but before the end of the expiration period. If customer 101 does not pick up the package before the end of the expiration period, the package is returned to merchant 102 at step 213. The customer may renew and extend the holding and expiration periods for additional fees.

A diverse group of merchants, depots and carriers works together to make the package delivery system of the present invention appear to the customer as a standard merchant order feature. The delivery system of the present invention is a closed loop system in the sense that depot server 151 tracks the delivery of the package to the depot so that the customer may be provided with up-to-date information as to its whereabouts. The depot server may receive package status information from the merchant, the carrier and the depot and provide the package status information to the customer.

Customers may select a depot delivery destination and track their packages from, e.g., their merchant's web page or with one toll free phone number. Tracking and location over the Internet provides convenience, because it may be done without leaving the merchant's Internet web page. The delivery system of the present invention provides greater package security, a high degree of reliable delivery, and facilitates the location and handling of lost or damaged packages. If desired, a home delivery option can be added for those consumers who wish to have their packages delivered to their home at their convenience at evening and weekend hours when traditional carriers do not deliver.

FIG. 3 also shows that payment flows from the customer at the time of order (PAY1) to the merchant through the merchant's existing payment systems (credit card, check, etc.). The merchant then pays the depot system operator (e.g., via electronic funds transfer) for use of the package delivery system of the present invention on a per package basis (PAY2). The depot server then pays its depots, e.g., via electronic funds transfer or check (PAY3). Carriers are generally paid by the merchants using their existing payment methods, and therefore they do not need be part of the payment loop of the present invention.

Package Bounce Back Systems and Methods

The tracking and delivery system of the present invention may also include a carrier bounce back service. Bounce back occurs when the carrier attempts to deliver the package to the customer's home address, and the customer is not home to accept the package. Rather than leaving the package at the customer's doorstep putting it at risk of theft or damage, the carrier may utilize the bounce back service of the present invention. The bounce back service may be utilized after several attempts to deliver the package.

The bounce back system of the present invention provides a network of depots as an alternative destinations for carriers. Carriers such as FedEx, Airborne and UPS often make several costly attempts to deliver a package to the customer. If the carrier does not deliver the package when the customer is home, the carrier bounces the package back to its often inconveniently located distribution centers (FedEx and UPS) or to the original shipper (Airborne), where the customer must go to pick up the package. In accordance with present invention, carriers may deliver these “bounce back” packages to a participating depot near the customer, thereby making pick up far more convenient for the customer.

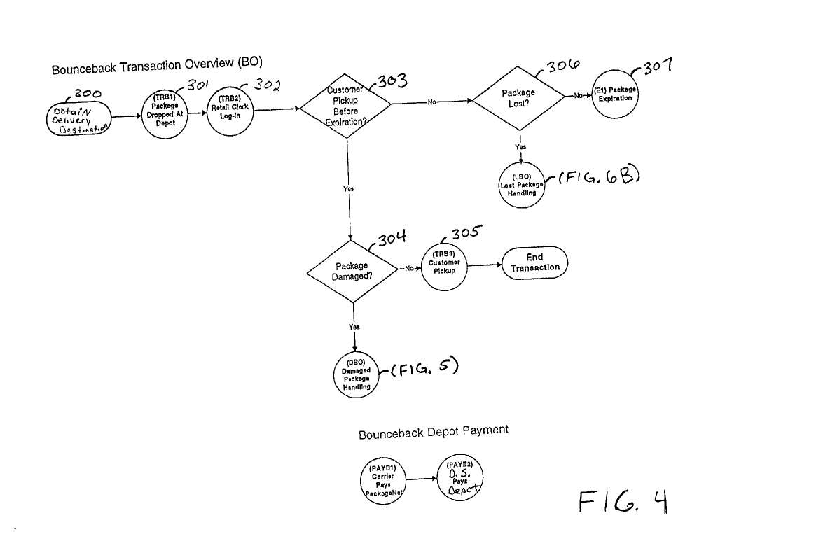

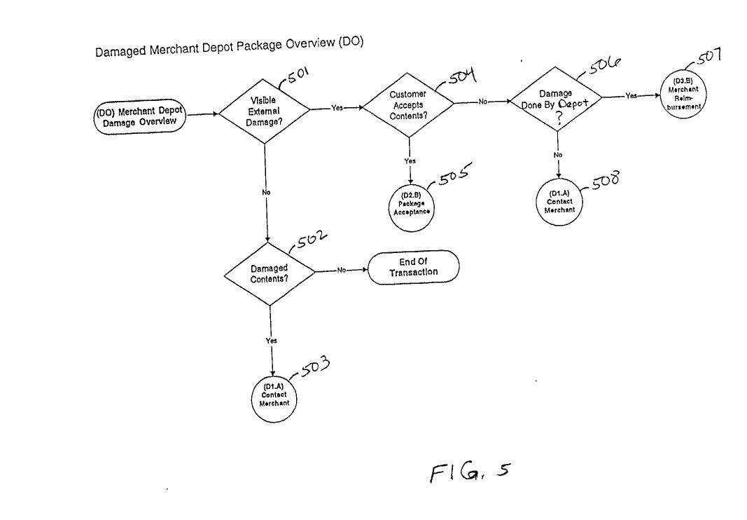

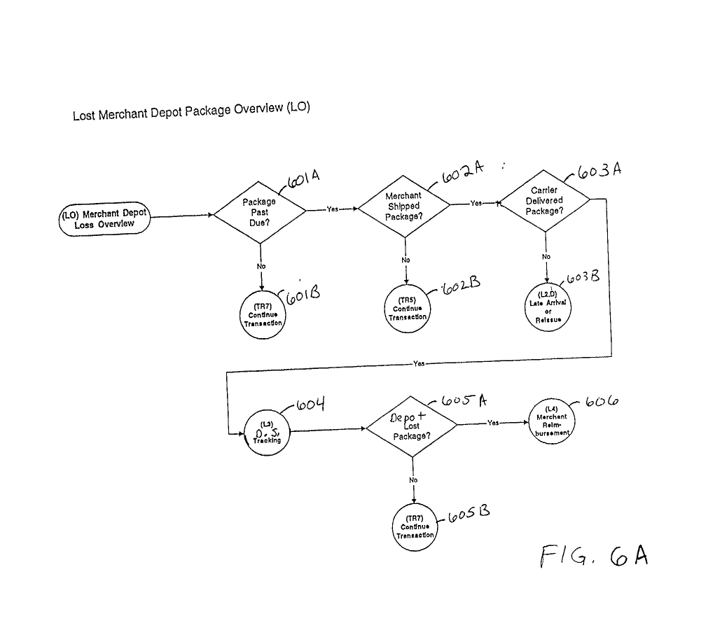

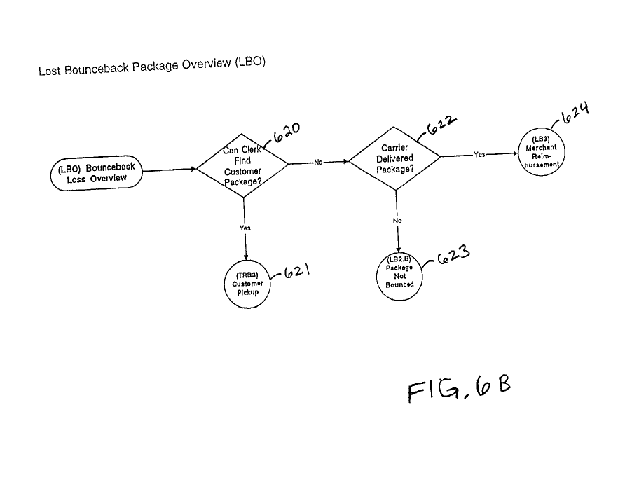

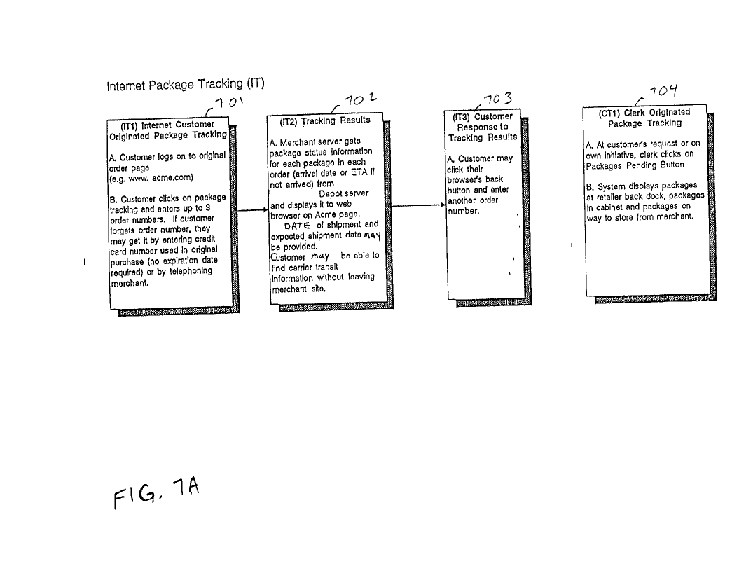

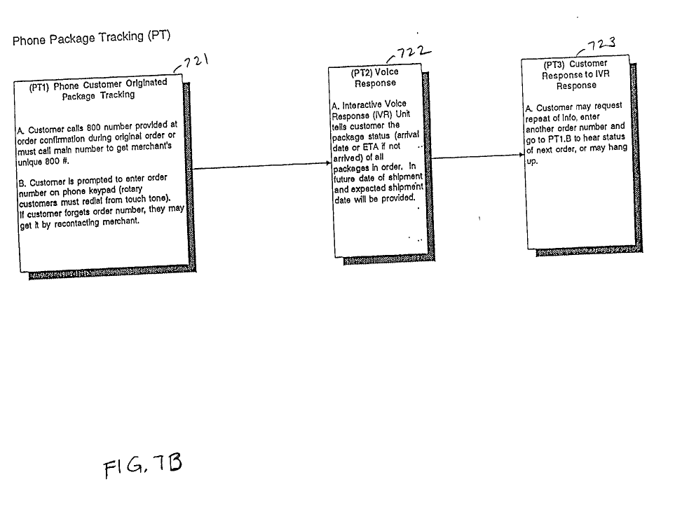

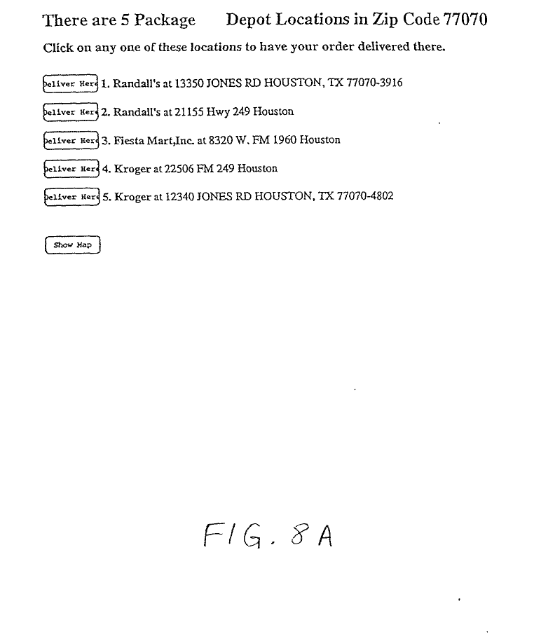

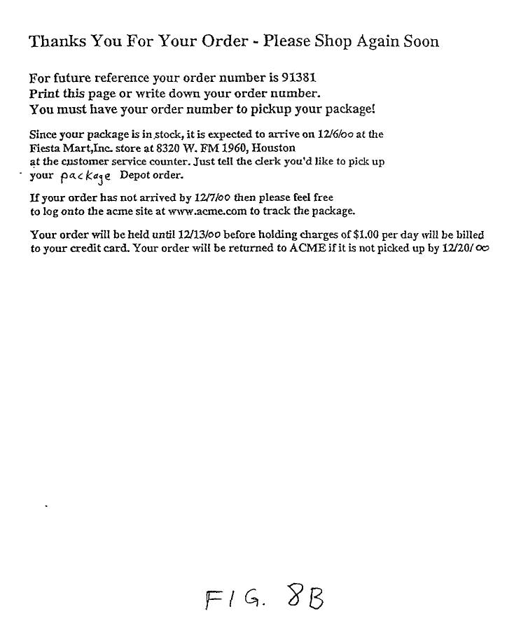

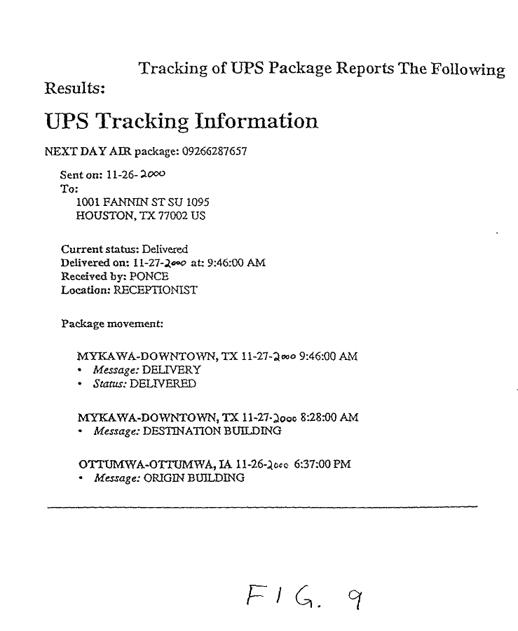

FIG. 4 shows a flow chart illustrating steps in an example package delivery bounce back system of the present invention. After the carrier has unsuccessfully attempted to deliver the package to the customer, the carrier may contact depot server 151 to obtain the identity of a depot delivery destinations in the customer's local area at step 300. The depots comprise potential delivery destinations where the package may be sent and held until customer pickup. If desired, a list of depot delivery destinations may be provided to the carrier through the mail or over the phone instead. The carrier may have a pre-printed list of depot delivery destinations on-hand for bounce back situations.

If desired, merchants or carriers may also provide delivery to a depot as an alternative option to home delivery, which customers may select on their bills at the time of shipment. The customer may also select a depot delivery destination as an alternative to home delivery at the time of purchase. The depot server then provides selected delivery destination to the carrier for bounce back delivery if the customer is not in when the package is delivered to the customer's home.

The carrier may leave a note with the customer indicating that the package is being delivered to a local depot delivery destination where it may be picked up by the customer at his/her convenience. The carrier may leave the depot's name and location where the package will be delivered and the tracking number of the package. The carrier may also provide the customer with a phone number to call to receive updated package delivery status information that is provided by depot server 151 in accordance with the principles of the present invention. If desired, an e-mail message may be sent to the customer identifying the depot where the package was sent. The carrier may also indicate the expiration period for pickup to the customer.

The carrier then takes the package to the depot's customer service counter. The carrier may electronically transmit updated package status information to depot server 151 indicating that that the package has arrived at the depot at step 301 . A depot clerk enters in the tracking number into the depot's computer and stores the package in a secure location. The clerk may write a portion of or all of the tracking number on the package. The depot's computer system then electronically transmits updated package status information to depot server 151 at step 302 indicating that the package has arrived at the depot.

When the customer comes to pick up the package, a determination is made as to whether the customer arrives to pick up the package from the depot before an expiration period at branch 303. If the customer does pick up the package before the expiration period, a determination is made as to whether the package is damaged at branch 304. If the package is damaged, damaged package procedures are implemented as discussed further below in connection with FIG. 5.

If the package is not damaged, the package is provided to the customer after the customer provides the package tracking or order number and his/her photo identification. A depot clerk gives the package to the customer and logs the package out from the depot's computer system at step 305. The clerk may log the package out by scanning a tracking number bar code on the package into the computer system. The depot's computer system then electronically communicates with the depot server indicating that the package has been successfully picked by the customer within the expiration period. The clerk may ask the customer to sign a release form indicating that he has received the package.

If the customer does not pick up the package at the depot before the end of the expiration period, a determination is made as to whether the package is lost at branch 306. The clerk may check with depot server 151 to see if the carrier ever delivered the package or whether the package was ever logged in at the depot. If depot server 151 and the depot system operator determine that the package is lost, lost package handling procedures are implemented as discussed further below in connection with FIGS. 6A-B. If the package is found, it is sent back to the merchant at step 307.

The bounce back tracking delivery system provides a convenient and cost effective way to deliver a package to a customer when home delivery is not successful. Depot server 151 provides a centralized and up-to-date system for maintaining current package status information that is accessible the customer at any time. If the package is lost or damaged, further procedures at taken, which are discussed below.

FIG. 4 also shows the payment flows. Depot server 151 bills the carriers (PAYB1) and pays the depots (PAYB2) periodically based on a fee per package dropped off at depot delivery destinations during regular time intervals.

Damaged Package Systems and Methods

FIG. 5 illustrates an exemplary set of steps that may be followed in accordance with the principles of the present invention when a package is damaged. If the package does not have visible external damage (branch 5(01), but the customer discovers that the contents are damaged (branch 502), the customer may notify the merchant, the depot, or the carrier. The merchant, depot, or carrier notifies the depot system operator, e.g., by sending an electronic message depot server 151 at step 503. The depot system operator then informs the carrier, the merchant, and/or the depot (if not already notified) that the merchandise has been damaged and logs the package as damaged into a depot server 151 package status database 166. If desired, depot server 151 may automatically inform the merchant, carrier, and/or depot when a package is damaged. If the contents of the package are not damaged and the customer accepts he package, the transaction is complete and the depot or merchant sends a message to depot server 151 indicating that the damage has been resolved so that information may be logged into database 166.

If a depot clerk discovers that the package has visible external damage at branch 501, the clerk then checks to see if the customer accepts the package at branch 504. If the customer accepts the package at step 505, the transaction is complete. If the customer does not accept the package, the depot may determine if a depot clerk is responsible for the damage at branch 506. If a depot clerk is responsible, the depot notifies depot server 151 which debits the depot's account for the damage and reimburses the merchant (or the customer) at step 507. If the depot is not responsible for the damage it notifies depot server 151, which notifies the merchant at step 508. The depot system operator then handles the claim resolution. Depot server 151 logs the package as damaged in package status database 166.

The depot system operator handles resolution of the claim according to its procedures to determine fault. For example, the depot system operator may check with the merchant or the carrier to determine if appropriate shipping procedures were followed by either or both parties. The depot system operator may determine that a clerk at the depot caused the damage if the package was handled properly in delivery. In this case, the depot system operator may transmit an invoice from the merchant to the depot for the cost of the damaged merchandise. If desired, the depot system operator may direct the depot to reimburse the customer directly for the damaged merchandise so that the merchant does not have to reship the merchandise. Depot server 151 may confirm the cost of the merchandise with the merchant before billing the responsible party.

Depot server 151 then records the situation as being resolved. Depot server 151 coordinates the flow of information between the relevant parties during a damaged package resolution procedure. By providing a neutral and centralized resolution system, disputes between the parties involved are minimized and the customer is compensated in a timely manner. The damaged package procedure shown in FIG. 5 may be used with a bounce back delivery or a direct depot delivery.

Lost Package Systems and Methods

FIG. 6A illustrates an exemplary set of steps that may be followed in accordance with the principles of the present invention when a package is lost in a direct depot delivery transaction. First, a determination is made as to whether the package is past due at branch 601A. This determination may be made by the depot. If the package is not past due the depot continues to await delivery at step 601B.

When it is discovered that a package is past due at branch 601A, a message may be sent to the merchant to determine if the package was shipped to the carrier at branch 602A. The depot or customer may send a message to the depot server which contacts the merchant. If the merchant did not ship the package, the merchant then ships the package at step 602B and the transaction continues. If it is determined that the package was shipped by the merchant at branch 602A, the merchant calls the carrier to see if the package was delivered at branch 603A.

If the package was not delivered by the carrier as agreed, the merchant may resolve the situation with the carrier and notify depot server 151 of the result and when delivery of the package will occur at step 603B. If the package was delivered as agreed, the merchant sends a message to depot server 151 indicating that the package is lost. Depot server 151 then implements lost package tracking procedures at step 604. Depot server 151 sends a message to the depot to as a notification that the package has been lost. The depot system operator coordinates with the depot to find the package.

A determination is then made by the depot system operator as to whether the package is lost and whether the depot is at fault at branch 605A. If the depot lost the package, depot server 151 directs the depot to compensate the merchant directly for the lost package or debits the depot's account and reimburses the merchant at step 606. If the package is found, the interactive voice response system or the depot system operator may call the customer to notify him to pick up the package at the depot at step 605B. Depot server 151 updates package status database 166 with package lost or found information as it is received by the participants.

If desired, the merchant or customer may notify the depot system operator through depot server 151 as soon as it is discovered that a package is lost. The depot system operator then contacts the carrier directly to determine if it received the package and if it was delivered to the correct location. If the package is located, the depot system operator indicates to the carrier where to deliver the package and notifies the customer and the merchant. If the package is lost and the carrier is at fault, the depot system operator directs the carrier to reimburse the merchant for the loss. If the carrier delivered the package to the correct depot, the depot system operator then contacts the depot to locate the package.

FIG. 6B illustrates an exemplary set of steps that may be followed in accordance with the principles of the present invention when a package is lost in a bounce back depot delivery transaction. First, the clerk attempts to find the package at branch 620. If the package is found, it may be delivered to the customer at step 621. A determination is then made as to whether the carrier delivered the package at branch 622. The depot may contact the depot server, which then contacts the merchant or the carrier. If the depot system operator determines that the carrier did not bounce the package to the depot at step 623, the customer must pick up the package at the carrier delivery center. If the depot system operator determines that the package was lost by the carrier, the depot server directs the carrier to reimburse the customer or the merchant at step 624.

The depot server 151 coordinates the flow of information between the relevant parties during a lost package resolution procedure. By providing a neutral and centralized resolution system, disputes between the parties involved are minimized and the customer is compensated in a timely manner.

Package Tracking Systems and Methods

The Internet customer may track his or her package at any time by accessing the data from the merchant web site where the order was made or by connecting directly to a web site that links to the depot server. The phone customer may track the package at any time by dialing the package status number provided at the time of order. After receiving the customer's order number, the interactive voice response (IVR) unit checks the depot server and voices the package status over the phone to the customer. Example package tracking states may include: “Not shipped, “Shipped and in transit,” “Delivered,” “Logged in,” “Picked up,” and “Invalid order number.”

FIG. 7A illustrates steps in an exemplary Internet package tracking system in accordance with the principles of the present invention. At step 701, the customer may log on the merchant's web site (or the depot system operator's web site). The customer enters the package order numbers on the appropriate web page when prompted. At step 702, the merchant downloads package status information from depot server 151 for each package order number entered and displays the information on the user's screen. The package status information may be maintained in database 166 as discussed above. Package status database 166 may provide the date of shipment, the expected date of arrival at the depot, the carrier tracking number for the package, the carrier name, method of shipment, and other relevant information to the customer through the merchant's or depot system's web site. At step 703, the customer may click the browsers back button to enter another order number.

If desired, a depot clerk may log onto the merchant web site to view tracking information for the package as shown in box 704. The depot connects to depot server 151 to access package status database 166 that stores the identity of packages that have arrived at the depot's back dock, packages that are stored in that depot's secure cabinet, and packages that are in transit to the depot from the merchant. The depot can access package status database 166 through depot server 151 to obtain package status information for packages that are being delivered to that depot including an estimated time of arrival.

FIG. 7B illustrates steps in an exemplary phone package tracking system in accordance with the principles of the present invention. At step 721, the customer calls a toll free number linked to interactive voice response system (IVR) 170 which tracks packages delivered in accordance with the present invention. IVR 170 prompts the customer to enter an order number through the phone key pad. IVR 170 then accesses package status database 166 and downloads package status information for the package corresponding to the order number entered by the customer. IVR 170 then relays the package status information for the package order numbers entered to the customer at step 722, for example, by providing an arrival date or an estimated time of arrival. The date of shipment and the expected shipment date of shipment may also be provided to the customer. At step 723, the information may be repeated, or the system may provide the customer with an opportunity to enter another order number or to hear the status of the next order. IVR 170 may provide the user with the ability to access package status information for multiple merchants on one phone call.

Example Delivery System Transactions

Examples of web page screens that may be used to guide the customer through the process of purchasing merchandise and selecting a depot delivery location in accordance with the present invention are shown in FIGS. 8A-8B. An Internet customer may purchase merchandise through a merchant's web site. The customer selects an item of merchandise on the web site, and enters his name, address, phone number and e-mail address. The customer then selects a method of transportation for delivery of the merchandise. If the customer selects a depot delivery option in accordance with the present invention, a web page is provided that prompts the user to enter, e.g., his home zip code or phone number. The merchant web server then contacts depot server 151 to obtain a list of nearby participating depot delivery destinations for the location information entered by the user.

Depot server 151 accesses the list of depots along with location and map information from depot location server 165 and transmits the data to the merchant web server for display to the user. A list of nearby depot delivery destinations may be displayed as shown in FIG. 8A. The customer selects a depot where she wishes to have the package delivered and held until he/she picks it up. The customer may select a map option to view a map of the depot delivery locations to determine which one is most convenient to her the merchant then confirms the customer's selection.

The web site then presents the user with the total charges including the cost of the merchandise, shipping, and depot delivery charges. The customer then enters payment information. After the customer enters his payment information, the merchant web site may then display an order confirmation web page indicating the order number for purchase, and an estimate time of arrival as shown in FIG. 8B. Holding charges and package tracking information (e.g., a toll free tracking number) may also be displayed in the order confirmation page. The merchant may send a confirmation e-mail to the customer that confirms the order and contains an order number and an expected data of arrival, instead of or in addition to displaying a confirmation web page.

The merchant then ships the package to the carrier and provides all of the order information to depot server 151. The carrier may use a bar code to identify the package. The carrier delivers the package to the depot, and scans in the tracking number into its computer system (i.e., a client computer), which communicates with depot server 151 to indicate that the package has been delivered. Depot server may send a message to the depot to indicate the package has arrived. The depot clerk then scans the bar code (i.e., tracking number) into the depot computer system (i.e., a client computer), which communicates with depot server 151 to indicate that the package has been received at the depot. Depot server 151 may notify the customer that the package has arrived via e-mail or an automatic voice message through IVR 170 The depot stores the package until pickup by the customer. When the customer picks up the package at the depot, a clerk scans in the tracking number again into the computer system, which notifies depot server 151 that the package has been picked up by the customer. Depot server 151 may require that depot and carrier clerks enter a password before database 166 may be updated with new package status information.

An Internet customer may track a package through a merchant or depot system web site. The web site may prompt the user to enter the order number to retrieve package status information. The web site then contacts depot server 151 to obtain package status data from package status database 166. The package status data is then transmitted to the web server and displayed on-screen. If the package has arrived, the screen may look like the screen shown in FIG. 9, which displays the tracking number, delivery date, and depot name and address. If the package has not been delivered, an expected date of arrival may be provided. If desired, depot server 151 may send an e-mail message to the customer, which indicates the package status data for the customer's order.

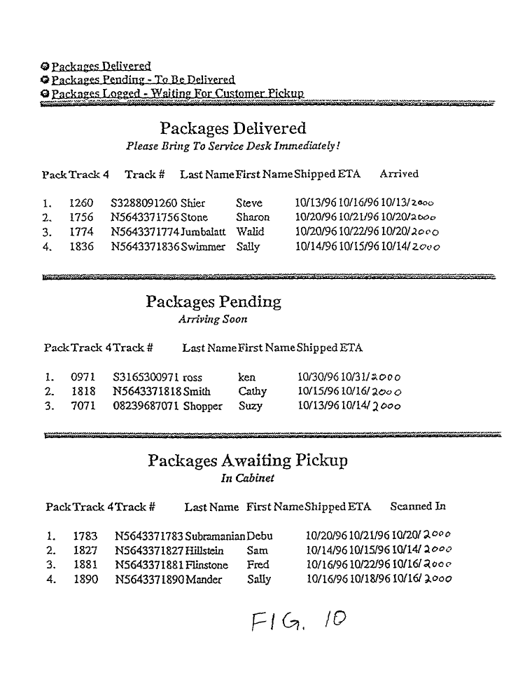

Depot server 151 may electronically transmit package status data to depots that may be used to help the depots keep track of packages delivered in accordance with the present invention. Depot server 151 may transmit to a depot a list of packages that have been delivered by the carriers to that depot, pending packages that are scheduled to be delivered to that depot, and packages that are stored in the depot cabinet and are awaiting customer pickup as shown in FIG. 10. The information in FIG. 10 may be obtained from package status database 166. The package status data may include a customer order number (Pack Track), a carrier tracking number (Track #), customer name, date shipped, an estimated time of arrival, an arrival date, and a date scanned in at the depot as shown in FIG. 10.

Sample Voice Transaction

An example voice transaction for interactive voice response (IVR) system 170 is now discussed. The transaction shown below may be followed when a customer calls a phone number to check the status of order numbers and to find other depot delivery destinations near their home. The first package has shipped from the merchant but has not arrived, the second package has arrived at the depot and is ready to be picked up, the third package has already been picked up (possibly by the customer's spouse). The IVR may, for example, track whether a package has been shipped from merchants, is due to arrive, has already arrived, and has been picked up.

1. Package Not Arrived Yet

IVR: Welcome to the SimplyPackages Depot tracking service. To-track something you have ordered from a catalog, press 1, to hear a list of locations near you, press 2.

Customer: Presses 1

IVR: Please enter the order number you were given by your catalog at the time of your order, followed by the pound sign. Use the corresponding number on your phone for any letters which may be in your order number. If you do not have this number, please contact the catalog from which you ordered. (Note: merchant order numbers will need to eliminate Q and Z which are not on phone keypads. It would be more desirable to restrict order numbers to purely numeric so the IVR could voice the order back to the customer).

Customer: Enters order number. For example, if the order number is AL34567, customer enters 2534567.

IVR: Please hold while we track your package. [SimplyPackages Advertisement plays] Your order is expected to arrive at the Kroger store at 123 Main St., in Houston on Jun. 15, 2000. Thank you for using the SimplyPackages Depot service. You may Press 1 to track another order, Press 2 to hear a list of locations near you, or hang up to complete this call.

2. Package Arrived

Customer: Presses 1.

IVR: Please enter the order number you were given by your catalog at the time of your order, followed by the pound sign.

(Note: the above message is shorter since instruction details were provided on the first tracking request.)

Customer: Enters order number.

IVR: Please hold while we track your package . . .[SimplyPackages Advertisement plays] . . . Your order arrived at the Kroger store at 123 Main St., in Houston on Jun. 10, 2000. To get your package, simply tell the clerk at the customer service counter your order number. Thank you for using the SimplyPackages Depot service. You may Press 1 to track another order, Press 2 to hear a list of locations near you, or hang up to complete this call.

3. Package Already Picked Up

Customer: Presses 1.

IVR: Please enter the order number you were given by your catalog at the time of your order, followed by the pound sign.

(Note: the above message is shorter since instruction details were provided on the first tracking request.)

Customer: Enters order number.

IVR: Please hold while we track your package. [SimplyPackages Advertisement] . . . Your order was picked up at the Kroger store at 123 Main St., in Houston on Jun. 10, 2000. If you believe this to be in error press 3 (connects to customer service). Thank you for using the SimplyPackages Depot service. You may Press 1 to track another order, Press 2 to hear a list of locations near you, Press 3 to speak to a SimplyPackages customer service representative or hang up to complete this call.

Conclusion

While the present invention has been described herein with reference to particular embodiments thereof, a latitude of modification, various changes and substitutions are intended in the foregoing disclosure, and it will be appreciated that in some instances some features of the invention will be employed without a corresponding use of other features without departing from the scope of the invention as set forth. Therefore, many modifications may be made to adapt a particular situation or material to the teachings of the invention without departing from the essential scope and spirit of the present invention. It is intended that the invention not be limited to the particular embodiment disclosed as the best mode contemplated for carrying out this invention, but that the invention will include all embodiments and equivalents falling within the scope of the claims. Therefore, the above description should not be taken as limiting the scope of the invention as defined by the claims.

What is claimed is:

1. A method for servicing a request for delivery of an item, the method comprising:
receiving delivery location information from a customer;
using said delivery address information to provide a set of delivery destinations to said customer, said set of delivery destinations being different from an actual address of said customer;
receiving from said customer a selected delivery destination from said set of delivery destinations; and
initiating a shipment transaction with a carrier to deliver the item to said customer, including providing said carrier with said selected delivery destination.

2. The method of claim 1 further comprising:
providing said customer with an order number associated with the item.

3. The method of claim 2 further comprising:
linking said order number to a carrier tracking number associated with the item.

4. The method of claim 1 wherein receiving said delivery location information from said customer further comprises receiving said delivery location information from said customer over the Internet.

5. The method of claim I wherein receiving said delivery location information from said customer further comprises receiving said delivery location information from said customer through an interactive voice response system.

6. The method of claim 1 wherein said set of delivery destinations provided to said customer are stored on a server.

7. The method of claim 1 further comprising:
providing package tracking information to said customer relating to said item through the Internet.

8. The method of claim 1 further comprising:
providing package tracking information to said customer relating to said item through an interactive voice response system.

9. The method of claim I further comprising:
receiving package status information from said carrier relating to delivery of said item to said customer.

10. The method of claim 9 further comprising:
providing said package status information to said selected delivery destination.

11. The method of claim I further comprising:
receiving arrival information from the selected delivery destination indicating when the item arrives at the selected delivery destination and storing said arrival information on a server.

12. The method of claim 11 further comprising:
receiving information from said selected delivery destination indicating that said item has been damaged.

13. The method of claim 11 further comprising:
receiving information from said selected delivery destination indicating that said item has been lost.

14. A method for servicing a request for delivery of an item, the method comprising:
providing a set of delivery destinations to a customer, the delivery destinations not including a home or business address of the customer;
receiving from the customer a selected delivery destination from the set of delivery destinations;
receiving package status information from a carrier chosen to deliver the item to the customer, the package status information relating to the delivery of the item; and
receiving package arrival information from the selected delivery destination indicating when the item arrives at the selected delivery destination.

15. The method of claim 14 wherein the package status information includes an arrival date or an expected arrival date.

16. The method of claim 14 wherein the package status information is stored on a server.

17. The method of claim 14 wherein the package arrival information from the selected delivery destination is stored on a server.

18. The method of claim 17 further comprising:
providing said arrival information to said selected delivery destination from said server on-demand.

19. The method of claim 14 further comprising:
providing the package arrival information to the customer through the Internet.

20. The method of claim 14 further comprising:
providing the package arrival information to the customer through an interactive voice response system.

21. The method of claim 14 further comprising:
receiving information from the selected delivery destination indicating that the item has been damaged.

22. The method of claim 14 further comprising:
receiving information from the selected delivery destination indicating that the item has been lost.

23. The method of claim 14 further comprising:
providing the package status information to the customer through the Internet.

24. The method of claim 14 further comprising:
providing the package status information to the customer through an interactive voice response system.

25. The method of claim 14 further comprising:
linking an order number for the item to a tracking number for the item used by the carrier.

26. A method for delivering a package to a customer, the method comprising:
providing a set of delivery destinations to a carrier that comprise alternatives to delivering the package directly to the customer;
receiving package arrival information from a selected one of the delivery destinations indicating the package has been delivered by the carrier to the selected delivery destination; and
receiving package pickup information from the selected delivery destination indicating that the package was picked up by the customer.

27. The method of claim 26 further comprising:
providing the package arrival information to the customer through the Internet.

28. The method of claim 26 further comprising:
providing the package arrival information to the customer through an interactive voice response system.

29. The method of claim 26 further comprising:
providing the package arrival information to the selected delivery destination on-demand.

30. The method of claim 26 further comprising:
storing the package arrival information and the package pickup information on a server.

31. A package delivery system, comprising:
a first server in electronic communication with a second server, a first client, and a second client operated by a carrier chosen to deliver a package to a customer;
wherein the first server provides a set of delivery destinations to the second server that comprise alternatives to delivering the package directly to the customer, the first server receives package status information from the second client, and the first server receives package arrival information from the first client operated by one of the delivery destinations.

32. The package delivery system of claim 31 wherein the first server provides the package status information and the package arrival information to the customer through the Internet.

33. The package delivery system of claim 32 wherein the first server links a customer order number with a tracking number for the package used by the carrier.

34. The package delivery system of claim 31 wherein the first server provides the package status information and the package arrival information to the customer through an interactive voice response system.

35. The package delivery system of claim 31 wherein the first server provides the package arrival information to the first client on-demand.

36. A method for servicing a request for delivery of an item, the method comprising:
receiving compensation from a merchant in exchange for a service of holding a package at a depot for customer pickup; and
providing compensation to the depot for the service of holding the package at the depot for customer pickup.
